(19) United States
(12) Patent Application Publication
(10) Pub. No.: US 2009/0209266 A1
(43) Pub. Date: Aug. 20, 2009

(54) Investigations

(75) Inventors: Amanda Goode, Birmingham (GB); Mark Stokes, Birmingham (GB)

Correspondence Address: MERCHANT & GOULD PC, P.O. BOX 2903, MINNEAPOLIS, MN, 55402-0903, US

(73) Assignee: Forensic Science Service Ltd., Birmingham (GB)

(21) Appl. No.: 10/592,292

(22) PCT Filed: Sep. 30, 2005
(86) PCT No.: PCT/GB05/03772

§ 371 Date: Mar. 25, 2009

(30) Foreign Application Priority Data
Sep. 30, 2004 (GB) 0421721.2
Aug. 18, 2005 (GB) 0516962.8

(51) Int. Cl. H04W 24/00

(52) U.S. Cl. 455/456.1

(57) ABSTRACT

A kit and method of investigating the location of a portable telecommunications device used in making a call, includes obtaining information on the position of the receiver involved in the call. A location is surveyed by visiting the location and establishing the receiver a portable telecommunications device would use from that location. The method also compares the receiver involved in the call with the receiver that would be used from the surveyed location.

This invention concerns improvements in and relating to investigations, particularly, but not exclusively, in relation to investigations into the location of a mobile phone at the time of a call.

Mobile phones and other portable telecommunication devices are increasingly used and as a consequence become involved directly or indirectly in crime. Forensic investigations of the use of such devices can, therefore, provide useful information.

The present invention has amongst its potential aims to improve the accuracy with which the possible locations of a portable telecommunications device at a particular time are identified.

According to a first aspect of the present invention we provide a method of investigating the location of a portable telecommunications device used in making a call, the method including:

obtaining information on the position of the receiver involved in the call;

surveying a location by visiting the location and establishing the receiver a portable telecommunications device would use from that location;

comparing the receiver involved in the call with the receiver that would be used from the surveyed location.

Preferably the method investigates the potential location and/or potential locations for the portable telecommunications device, optionally at a given time.

Preferably the method includes obtaining information on the identity of the receiver involved in the call.

Preferably the method includes obtaining information on the time of the call.

Preferably the method involves repeating the survey for one or more further locations.

Preferably the method includes establishing the locations for which the receiver involved in the call would be the receiver used by the portable telecommunications device.

Preferably the location surveyed is the location which is a claimed location of use.

Preferably the method includes establishing whether the receiver involved in the call is the same as the receiver that would be used from a location in respect of the claimed location of use.

The first aspect of the invention may include any of the features, options and possibilities set out elsewhere in this document.

According to a second aspect of the invention we provide a method of investigating the potential locations for a portable telecommunications device at a given time, the method including:

obtaining information on the time of a call;

obtaining information on the identity and position of the receiver involved in the call;

surveying a location by visiting the location and establishing the receiver a portable telecommunications device would use from that location;

repeating the survey for one or more further locations;

establishing the locations for which the receiver involved in the call would be the receiver used by the portable telecommunications device.

The second aspect of the invention may include any of the features, options and possibilities set out elsewhere in this document.

According to a third aspect of the invention we provide a method of investigating the potential location for a portable telecommunications device at a given time, the method including:

obtaining information on the time of a call;

obtaining information on the identity and position of the receiver involved in the call;

surveying a location by visiting the location and establishing the receiver a portable telecommunications device would use from that location, the location being a claimed location of use;

establishing whether the receiver involved in the call is the same as the receiver that would be used from a location in respect of the claimed location of use.

The third aspect of the invention may include any of the features, options and possibilities set out elsewhere in this document.

The various aspects of the invention may include features, options or possibilities from amongst the following.

The device may be a transmitter. The device may incorporate a receiver. The device may use radio-waves. The device may use emissions of a frequency between 750 kHz and 2500 kHz. The frequency may be between 900 kHz and 1800 kHz. The device may be a mobile phone. The device may be a device capable of accessing the Internet, such as a portable computer.

The call may involve one way or two way communication. The call may involve voice transmission. The call may involve data transmission. The call may involve short message service transmission. The call may involve transmission of a text message. The call may involve the device's, potentially automatic, response to an interrogation signal from a receiver.

The information on the position of the receiver may be obtained from the owner and/or operator of the receiver and/or network of which the receiver is a part. The information may include data on the geographical position of the receiver. The data may be presented in a format consistent with the format used for the data on the location or locations surveyed. The information on the receiver may include a unique identifier for the receiver. The position of the antenna may be measured as part of the method, particularly part of the survey.

The receiver may be an antenna, for instance an antenna forming part of a mobile phone network. The receiver may also be a transmitter.

The receiver may be involved in the call at some point during the duration of the call. The receiver may be involved in the call by being the first receiver used during the call.

The surveying of a location may involve the measurement of the location's whereabouts. The measurement of the location may be recorded. The measurement may be recorded in a format consistent with the format used for the data on the position of the receiver. The measurement may be made using a device employing the global positioning system.

The establishment of the receiver a portable telecommunications device would use from that location may be made using a detector. The detector may be a portable telecommunications device, such as a mobile phone. The detector may be specifically designed for the purpose of the method. The establishment of the receiver may include measuring the receiver identity indicated as being available to receive calls from that location. The telecommunications network may determine which of a number of receivers is available to take calls from a particular location.

The comparison of the receiver involved in the call with the receiver that would be used from the surveyed location may involve comparing the location information for each. The comparison may establish that the location information matches and/or that the location information does not match.

The method may investigate one or more potential locations for the portable telecommunications device, optionally at a given time. The method may investigate a plurality of locations, ideally so as to determine the extent of an area. Preferably the area is the area for which the receiver that would be used applies. The method may investigate a plurality of locations, ideally so as to determine the boundary of an area or boundaries of areas. The boundary or boundaries may define the limits which apply to the receiver that would be used.

Preferably the method includes obtaining information on the start time of the call.

The method may investigate a location which is a claimed location of use for the device. Preferably the method includes establishing whether the receiver involved in the call is the same as the receiver that would be used from a location in respect of the claimed location of use.

The method may investigate the location and/or locations and/or area and/or areas from which the call to the receiver could have been made.

The method may investigate whether a call from a location and/or locations and/or area and/or areas could have been made through the receiver.

The method may further include making one or more test calls. The test calls may be made from one or more of the surveyed locations. The test calls may be made from one or more other locations. The test calls may be made before and/or during and/or after the survey. The receiver involved in the one or more test calls may be monitored and/or recorded.

The method may be performed within a range of time around the time of the call. The range may be the time of the call plus or minus 1 hour, preferably plus or minus 30 minutes and ideally plus or minus 15 minutes.

The method may be performed on the same day of the week as the call. If the call was made on a week day then the method may be performed on a weekday. If the call was made at the weekend then the method may be performed at the weekend.

The method may be performed with the network, or at least the part thereof in the vicinity, of which the receiver is a part under one or more operating conditions which are the same as at the time of the call. The vicinity may mean the receiver itself and/or one or more adjacent receivers and/or one or more of the receivers adjacent to those. The conditions may be the receivers available for use. The conditions may be the level of use on one or more of the receivers locally. The conditions may be the technology operated by the network. The conditions may be the same by virtue of, one or more of, the time of day and/or the day of the week and/or natural and/or artificial traffic on the network and/or enablement and/or disablement of receivers in the network and/or reinstatement of the technology used on that part of the network at that time.

The method may account for changes in the receiver and/or at one or more of the locations and/or at one or more other points in the area of the receiver and/or locations. Changes may be the addition of receivers to the network and/or the removal of receivers from the network. Changes may be one or more of, new buildings and/or changes in buildings and/or demolition of buildings and/or changes in extent or shape of buildings. The method may account for the changes by reversing the change, at least temporarily, and/or by simulating the effect of the change. The simulation of the change may be achieved by taking the investigation results and modifying them, for instance, using a computer simulation.

The results of the investigation may be used to assist further investigations by law enforcement authorities and/or in criminal investigations and/or in legal proceedings and/or in court.

The locations used in the survey may be in a predetermined pattern relative to one another. A grid pattern of locations may be used in the survey. The locations may be surveyed in a predetermined order. The locations may be surveyed starting near the position of the receiver and working out therefrom. The locations may progress outward in a radial manner. The locations surveyed may stop once a location has been reached for which the same receiver a device would use changes. Further locations may be surveyed outward of a location at which the receiver a device would use changes. The locations surveyed may vary vertically as well as horizontally from one another. Locations at different heights may be surveyed. The locations of different heights may be in buildings and/or man-made topographical features and/or natural topographical features.

The locations established as being locations for which a device would use the same receiver may form one or more areas.

According to a fourth aspect of the present invention we provide a kit, the kit comprising:

a detector for establishing the receiver a portable telecommunications device would use from a location;

a detector for establishing the position of the location;

a data recording unit for data including the receiver that would be used from a location and the position of the location.

Preferably the kit is for use in investigating the location of a portable telecommunications device used in making a call. at a given time. The kit may be for use in investigating the potential location and/or potential locations for a portable telecommunications device at a given time.

The detector for establishing the receiver may be a portable telecommunications device, such as a mobile phone.

The detector for establishing the position of the location may use the global positioning system. The detector may be a GPS unit. The GPS unit may be integral with the detector for establishing the receiver and/or the data recording unit. The GPS unit may be separate and/or separable from one or more of the other components of the kit.

The kit may further include a portable telecommunications device, such as a mobile phone. The kit may include a data link to convey information on the receiver the portable telecommunications device in the kit uses when a call is made to the data recording unit.

The kit may further include a memory, preferably a memory adapted to store information on the receiver used in a call and/or the time of a call. The memory may be provided with map data, for instance indications of roads and/or buildings and/or height and/or contours.

The kit may further include a display, ideally for presenting the user with information on the receiver that would be used from a location and/or the signal level between the detector and/or receiver and/or the position and/or map data. One or more pieces of information may be overlain on one or more of the other pieces of information. The display may indicate the boundary between one receiver being used and one or more other receivers.

The fourth aspect of the invention may include any of the features, options and possibilities set out elsewhere in this document.

Various embodiments of the present invention will now be described, by way of example only, and with reference to the accompanying drawings, in which:—

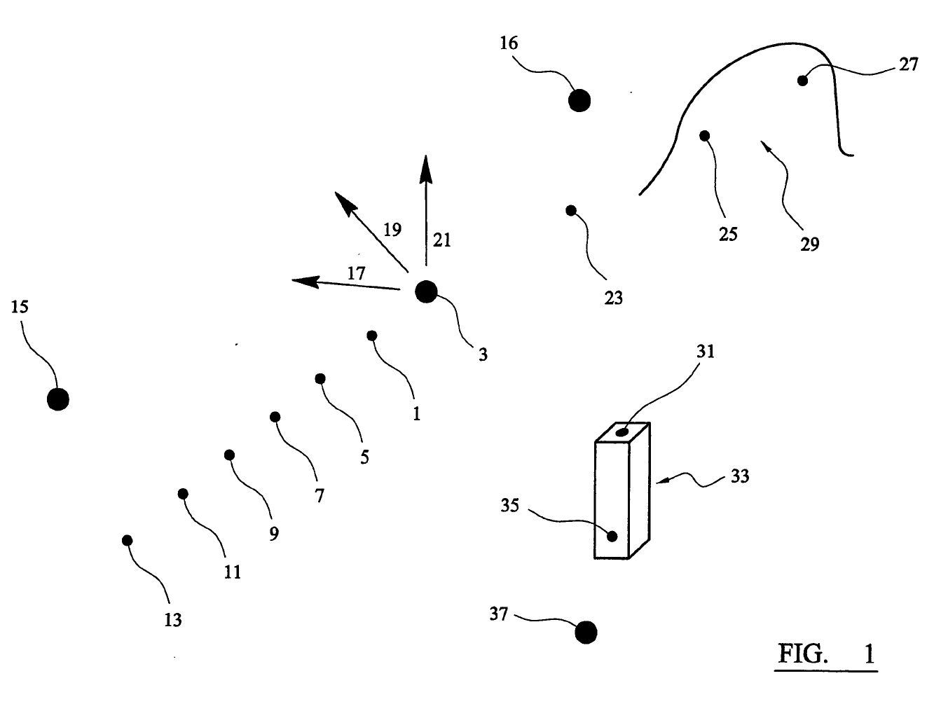

FIG. 1 is a schematic illustration of the survey of the cell boundaries for a antenna according to an embodiment of the present invention;

Mobile phones and other portable telecommunication devices are increasingly being used. They are now used by a substantial part of the population in many countries on a regular basis. As such, data from portable telecommunication devices can provide useful information in the context of forensic investigations. Such devices generally transmit in the range 900 kHz to 1800 kHz.

When a mobile phone call is started, the phone connects to the network using an antenna at a position somewhere in the locality. Whilst mobile phones can connect to antenna up to 35 km or so distance, in most cases the antenna is at a position considerably closer than that. Within cities and other high population/use areas, a large number of antenna are provided in close proximity with one another to ensure that where ever a user is they can make and receive calls. The telecommunications operating companies keep details of the antenna through which a call is started and the time the call started. This information can be released to law enforcement authorities in appropriate circumstances.

Knowledge of the position of antenna through which the call started is presently combined with databases detailing “best service” information to suggest the location where the mobile phone might have been when the call started. The “best service” information, however, may be out of date, is often a prediction based on a computer simulation and does not take account of other variables such as the time of day when the call was made.

In the methodology of the present invention, a different approach to the consideration of which location or locations the phone might have been when the call was started is taken.

Taking as an example the question a particular phone X made a call, what was its location? the question is answered in the following manner.

Firstly, the identity of the antenna used when the call started and the time of the call start is obtained from the relevant telecommunications company. The geographic position of this antenna is then identified from the records of the telecommunications company; all antenna have a unique identifier.

A surveyor then visits the position of the antenna and starts a detailed investigation of the locations in the surrounding area. The surveyor starts close to the antenna, verifies that his detector would connect to the antenna at that first location and records the position of that first location. A unit using the global positioning system, GPS, is suitable for establishing the whereabouts of the first location. It is preferred that two different forms of GPS based position are recorded for each location; one according to the best accuracy which might apply to the GPS location suggested and the other according to the worst possible accuracy which might apply to the GPS location suggested.

The surveyor then moves to a series of further locations and repeats the process. The surveyor can use a specially provided instrument for this purpose or even certain categories of mobile phones through which the antenna identity can be seen in certain diagnostic modes.

As shown in FIG. 1, the surveyor starts at location 1 close to the position of the antenna 3 identified as being involved. The surveyor then progresses radially outwards from location 1, through locations 5, 7, 9 and 11. At each of these the same antenna 3 is verified as being the relevant antenna for a call. By location 13, however, the survey reveals that antenna 15 is the relevant antenna for any call. This radial survey process is repeated in a series of other directions, arrows 17, 19 and 21. As well as conducting the survey outward at the ground level applying in the immediate vicinity of the antenna 3, due account must be taken of higher locations where antenna 3 may become the relevant antenna again. In FIG. 1, this is illustrated by locations 25 and 27 which are on a hill 29 and for which antenna 3 is the relevant one, even though at intermediate location 23 the relevant antenna is antenna 15. An elevated location 31 in a building 33 can have the same effect, even though a lower location 35 in that building may have antenna 37 as the relevant antenna. The survey gradually builds up a three dimensional map of the area around antenna 3 and the locations from which it is the relevant antenna. The boundaries between the cell for that antenna and the cell for the surrounding relevant antennas within the network are thus identified.

Such a real world survey gives a far greater level of accuracy in terms of the what was the location of phone X question that has been possible to date.

To verify the answer still further, it is possible to make a series of actual phone calls, during and/or after, the survey described above. These may be made from the various locations or may be made at additional locations. Further confirmation of the actual relevant antenna and the bounds of its cell are defined as a result.

The signal strength at the various locations in the survey and/or for the test calls can be recorded as part of the survey, but is not essential to the approach.

An alternative question that can readily be answered by the present methodology is it is claimed that phone X made the call from location Y, is that possible? The answer to this question comes from establishing the relevant antenna to the call and then seeing whether it could possibly have been the relevant antenna for the location claimed and its surround. Another relevant antenna may be reported as a result, so indicating the call was not made from the claimed location, or the relevant antenna may be reported, so confirming the call could have been made from that location.

To increase accuracy as far as possible, further features over the basic approach can be applied. Firstly, it is preferred that the survey be conducted as far as possible at the same time of day as the time of day logged for the call of interest. The time of day may be important for a number of reasons. Firstly, the relevant antenna for a location from which a call is made can vary according to the particular time of day and/or according to the particular day of the week. An antenna close to a railway station may become fully occupied during the rush hour, day in day out. As a result, the telecommunications network may direct a call made at that time though a nearby antenna. Thus the cell boundaries may vary with time of day. The same scenario can be used to indicate the relevance of the day of the week during the survey. Monday to Friday, the rush hour happens day in day out, however, the traffic through the station is far less at the same time on a Sunday and so the number of call made may be far less. The cell boundary at 8.30 am on a Sunday may be quite different to the boundary at 8.30 am on a Monday. The survey can take this into account.

As well as regular variations of the type mentioned in the above paragraph, other variations may apply. Some of these are predictable in advance, others less so. The end of a major event, such as a football match or concert can be predicted to cause the immediate antenna to become full and others become used. The breakdown of a train can result in less foreseeable heavy traffic and hence alternative antenna being used. Again undertaking the survey under equivalent conditions on another occasion can improve the accuracy of the survey. As an alternative, the same effect can be surveyed by the telecommunications company disabling or artificially filling the capacity of the antenna which was full at the time in question, during the survey to establish the cell boundaries.

Changes in the locality of the antenna between the time of the call and the time of the survey can also be taken into account to improve accuracy. For instance, new antenna may have been added to the network between the call and the intended time for the survey. The resulting changes in the cell boundaries can be accounted for, for instance by disabling or otherwise removing the new antenna from consideration during the survey. Other changes, such as systems upgrades, new technologies and the like can similarly be accounted for. Other physical changes in the area in question can also be beneficially accounted for. For instance, the progress on a new building in the area of the antenna can change the cell boundaries by obscuring the antenna from locations it was previously the relevant antenna for. Demolitions can have an effect to. Whilst in some cases, such as expandable gas holders the position can be mimicked, in most cases it will not be practical to put back such physical changes in many cases and so they are accounted for through theoretical calculations of their effect.

1. A method of investigating the location of a portable telecommunications device used in making a call, the method comprising:
obtaining information on the position of the receiver involved in the call;
surveying a location by visiting the location and establishing the receiver a portable telecommunications device would use from that location;
comparing the receiver involved in the call with the receiver that would be used from the surveyed location.

2. A method according to claim 1, wherein the method includes establishing the locations for which the receiver involved in the call would be the receiver by the portable telecommunications device.

3. A method according to claim 1, wherein the location surveyed is the location which is a claimed location of use and the method includes establishing whether the receiver involved in the call is the same as the receiver that would be used from a location in respect of the claimed location of use.

4. A method according to claim 1, wherein the device is a mobile phone and/or is a device capable of accessing the Internet, such as a portable computer.

5. A method according to claim 1, wherein the call involves voice transmission and/or data transmission and/or short message service transmission and/or transmission of a text message and/or the device's response to an interrogation signal from a receiver.

6. A method according to claim 1, wherein the method investigates a plurality of locations so as to determine the extent of an area for which the receiver that would be used applies.

7. A method according to any claim 1, wherein the method is performed within a range of time around an equivalent time of day to the time of the call, the range being the time of the call plus or minus 1 hour.

8. A method according to claim 1, wherein the method is performed on an equivalent day of the week as the call.

9. A method according to claim 1, wherein the method is performed with the network, or at least the part thereof in the vicinity, of which the receiver is a part under one or more operating conditions which are the same as at the time of the call.

10. A method according to claim 9, wherein the conditions are the receivers available for use and/or the level of use on one or more of the receivers locally and/or the technology operated by the network and/or that the conditions are the same by virtue of, one or more of, the time of day and/or the day of the week and/or natural and/or artificial traffic on the network and/or enablement and/or disablement of receivers in the network and/or reinstatement of the technology used on that part of the network at that time.

11. A kit, the kit comprising:
a detector for establishing the receiver a portable telecommunications device would use from a location;
a detector for establishing the position of the location;
a data recording unit for data including the receiver that would be used from a location and the position of the location.
